(19) United States
(12) Patent Application Publication
(10) Pub. No.: US 2025/0206311 A1
(43) Pub. Date: Jun. 26, 2025

(54) METHOD FOR CLOSED-LOOP CONTROL OF A REMAINING DISTANCE FOR A VEHICLE

(71) Applicant: MERCEDES-BENZ GROUP AG, Stuttgart (DE)

(72) Inventor: Marius GEMEINHARDT, Ergenzingen (DE)

(21) Appl. No.: 18/852,043

(22) PCT Filed: Feb. 27, 2023
(86) PCT No.: PCT/EP2023/054838

§ 371 Date: Sep. 27, 2024

(30) Foreign Application Priority Data
Mar. 31, 2022 (DE) 10 2022 001 119.0

(51) Int. Cl. B60W 30/18; B60W 30/182; B60W 40/06

(52) U.S. Cl. CPC B60W 30/18109; B60W 30/182; B60W 40/06; B60W 2552/15; B60W 2554/80

(57) ABSTRACT

A method for closed-loop control of a remaining distance for a vehicle to stop the vehicle at a specified stopping position is used in a maneuver in which the vehicle is guided to the specified stopping position in several maneuver moves. The individual maneuver moves each end in a target position where the vehicle is to be stopped. A current situation is determined considering an already performed maneuver move. Depending on the specific current situation, a selection is made as to whether the vehicle is to be operated in the comfort mode or in the high-precision mode. The selection is based on a comparison of the current situation with a list of specified situations. It is predetermined in the list for each of the specified situations, whether the remaining distance control is to be carried out in the comfort mode or in the high-precision mode in the respective situation.

### BACKGROUND AND SUMMARY OF THE INVENTION

Exemplary embodiments of the invention relate to a method for closed-loop control of a remaining distance for a vehicle in order to stop the vehicle at a specified stopping position.

DE 10 2021 005 088 A1 discloses a method for closed-loop or open-loop control of a longitudinal movement of a vehicle according to a target trajectory planned as a function of a detected surroundings situation. To stop the vehicle precisely at a stopping position specified by the target trajectory, the system switches from closed-loop acceleration control to closed-loop or open-loop distance control before the vehicle is brought to a standstill. To stop the vehicle precisely at the stopping position specified by the target trajectory, the system switches from closed-loop acceleration control to closed-loop or open-loop distance control before the vehicle is brought to a standstill when the speed falls below a specified speed threshold value.

A method for carrying out an automatic driving maneuver is known from DE 10 2016 006 213 A1, in which a vehicle is stopped in a closed-loop controlled manner at a specified stopping point, wherein the controlled stop occurs in a speed mode designed for comfort or in a more precise acceleration mode, and wherein the selection of the mode is made depending on a remaining distance to the stopping point.

A method and a device for automatically selecting a driving mode in a vehicle while driving along a route is known from DE 10 2014 215 259 A1, wherein preview information is detected that relates to the route lying ahead of the vehicle and wherein the driving mode is selected based on the detected preview information.

A method and a device for controlling a vehicle to a target position is known from DE 10 2018 207 964 A1, wherein an orientation of the vehicle to the target position is specified and wherein a trajectory leading to the target position is specified taking into consideration the orientation of the vehicle to the target position and a direction from a current position to the target position.

A method and device for the closed-loop control of a longitudinal speed of a vehicle during an automatically performed driving maneuver is known from DE 10 2020 201 921 A1, wherein a destination point is specified, and a target speed of the vehicle is determined based on a remaining distance from a current vehicle position to the destination point.

Exemplary embodiments of the invention are directed to a novel method for closed-loop control of a remaining distance for a vehicle in order to stop the vehicle at a specified stopping position.

In the method for closed-loop control of a remaining distance for a vehicle in order to stop the vehicle at a specified stopping position, the remaining distance control is carried out in one of either of two modes, wherein one of the two modes is a comfort mode, i.e., a mode configured for comfort, and the other mode is a high-precision mode, i.e., a mode configured for a high degree of precision. This means that the mode in which the remaining distance control is carried out is set selectively, i.e., based on a selection, and thus can be selectively switched between the comfort mode and the high-precision mode. The method is used in the case of multiple-move maneuvers, in which the vehicle is guided to the specified stopping position in several maneuver moves. These individual maneuver moves each end in a target position at which the vehicle is to be stopped. A current situation is determined taking into consideration at least one already performed maneuver move, in particular taking into consideration maneuver performance accuracy of the at least one already performed maneuver move. Depending on the current situation, a selection is made as to which of the two modes the remaining distance control is to be carried out in, i.e., whether the remaining distance control is to be carried out in the comfort mode or in the high-precision mode. The selection is based on a comparison of the current situation with a list of specified situations. The mode in which the remaining distance control is to be carried out is predetermined in the list for each of the specified situations. It is therefore predetermined in which of the specified situations the remaining distance control is to be carried out in the comfort mode and in which of the specified situations the remaining distance control is to be carried out in the high-precision mode.

The current situation is compared to the list with the specified situations, preferably by identifying a specified situation corresponding to the current situation in the list with the specified situations as a function of the current situation and selecting the mode predetermined for this situation in order to carry out the remaining distance control. In particular, it is determined which of the listed specified situations best matches the current situation and a predetermined mode is selected as the mode for this situation, in which the remaining distance control is to be carried out.

A real remaining distance control is inherently subject to scatter along an entire chain reaction, which can result in maneuvers that are inconvenient or incomprehensible for a user of the vehicle. In particular, target braking actions are subject to a standard distribution. The present method advantageously enables a situation-specific remaining distance control by switching between the comfort mode and the high-precision mode, which minimizes a number of unnecessary hard and uncomfortable braking actions of the vehicle during a multiple-move maneuver. In the case of an automated parking process of a vehicle, for example, it is possible to bring a longitudinally guided assistance function of the remaining distance control closer to human maneuvering behavior and thus significantly increase comfort. This significantly improves the customer experience in terms of assisted maneuvering of the vehicle.

In a possible embodiment of the method, the current situation, in particular the maneuver performance accuracy based on which the current situation is determined, is determined taking into consideration a stopping accuracy with which the vehicle has reached the respective target position in at least one maneuver move.

In a further possible embodiment of the method, the current situation, in particular the maneuver performance accuracy based on which the current situation is determined, is determined taking into consideration at least one maneuver move which has been completed at an early stopping point before reaching the respective target position.

In a further possible embodiment of the method, the current situation, in particular the maneuver performance accuracy based on which the current situation is determined, is determined taking into consideration at least one maneuver move, during or after the performance of which a remaining distance to the respective target position falls below a specified value.

In a further possible embodiment of the method, scatter in the stopping accuracies of all of the performed maneuver moves is determined and stored and is taken into consideration when determining the current situation. The scatter thus influences the selection of the mode and is thus taken into consideration when continuing the maneuver with each subsequent maneuver move. This enables, for example, an interface between a trajectory controller and a higher-level or lower-level controller to incorporate scatter in the remaining distance control into a trajectory control or remaining distance specification. This enables a further improvement in the imitation of human maneuvering behavior.

In a further possible embodiment of the method, the current situation is determined taking into consideration a pitch of a surface that the vehicle drives on and/or a clearance between the vehicle and at least one obstacle. This allows a simple and reliable estimation and determination of the situation in a particularly advantageous manner. By considering the clearance when controlling the remaining distance and making the switch, a high level of comfort for the vehicle user can be achieved particularly frequently depending on the situation. By taking the pitch of the driving surface into consideration, the vehicle can be started up more quickly in a maneuver.

In a further possible embodiment of the method, in the comfort mode, in comparison to the high-precision mode,
a greater possible number of allowed maneuver moves of the vehicle is specified, during or after the performance of which a remaining distance falls below a specified value and/or
a greater possible number of allowed maneuver moves of the vehicle that are completed at an early stopping point is specified and/or
an earlier possible point in time for a starting process in a maneuver move is permitted and/or
a greater target smoothness of a braking process up to a target position is specified and/or
the vehicle is permitted to roll back when starting on an incline and/or driving over a curb and/or
a greater tolerance is permitted with respect to exceeding a maximum speed of the vehicle and/or
a reduced reproducibility of a maneuver move is permitted and/or
an acceleration of the starting process is permitted while adhering to a total duration of a maneuver move, an acceleration for reaching the maximum speed is permitted and a greater smoothness of a braking process at a target position is specified.

By means of the comfort mode being designed and executed in this way, the comfort of the vehicle user can be optimized.

In a further possible embodiment of the method, in the high-precision mode, in comparison to the comfort mode,
a smaller possible number of allowed maneuver moves of the vehicle is specified, during or after the performance of which a remaining distance falls below a specified value and/or
a continuation of maneuver moves of the vehicle, which are completed at an early stopping point, is permitted and/or
later points in time for starting processes in maneuver moves are permitted and/or
a reduced target smoothness of a braking process up to a target position is permitted and/or
the vehicle is not permitted to roll back when starting on an incline and/or driving over a curb and/or
a smaller tolerance is permitted with respect to exceeding a maximum speed of the vehicle and/or
an increased reproducibility of a maneuver move is specified and/or
a low prioritization of adhering to a total duration of a maneuver move permitted.

By means of the high-precision mode being designed in this way, assisted maneuvers can be performed particularly precisely and reliably.

### BRIEF DESCRIPTION OF THE DRAWINGS

Exemplary embodiments of the invention are explained in more detail in the following with reference to drawings.

Here:

FIG. 1 schematically shows a plan view of a traffic situation,

FIG. 2 schematically shows a plan view of a traffic situation,

FIG. 3 schematically shows a probability that there will be remaining distances after a vehicle carries out targeted braking,

FIG. 4 schematically shows a dependency diagram of different parameters of a remaining distance control,

FIG. 5 schematically shows the dependency diagram according to FIG. 5 with a weighting of the parameters of the remaining distance control,

FIG. 6 schematically shows the dependency diagram according to FIG. 5 with a further weighting of the parameters of the remaining distance control,

FIG. 7 schematically shows a block diagram of a system for a remaining distance control for a vehicle, and

FIG. 8 schematically shows a remaining distance and a vehicle speed over time.

Parts corresponding to each other are provided with the same reference signs in all the figures.

### DETAILED DESCRIPTION

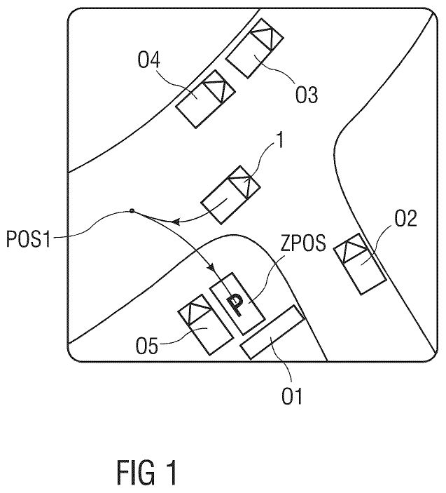

In FIG. 1, a plan view of a traffic situation with a vehicle 1 and several objects O1 to O5 is represented. The object O1 is a wall and the objects O2 to O5 are vehicles.

In the traffic situation shown, a clearance R between the vehicle 1 and the objects O1 to O5, which form obstacles for the vehicle 1 during a parking maneuver of the vehicle 1, is relatively large.

The vehicle 1 performs an automated parking maneuver in two maneuver moves. A target position POS1 of a first maneuver move is located on a road, wherein the vehicle 1 reverses from its starting position shown to reach this target position POS1 and steers to the left. A target position ZPOS of the entire parking maneuver, i.e., after completing a second maneuver move, is located on a parking space next to the object O5 and in front of the object O1, formed as a wall. The vehicle 1 reaches this target position ZPOS, starting from the target position POS1 of the first maneuver move, by driving forwards and steering to the right.

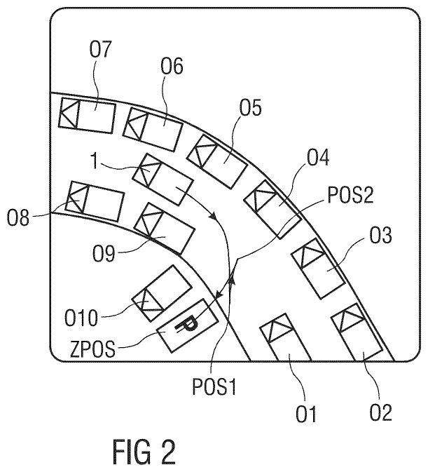

FIG. 2 shows a plan view of a traffic situation with a vehicle 1 and several objects O1 to O10. The objects O1 to O10 are vehicles.

In the traffic situation shown, a clearance R between the vehicle 1 and the objects O1 to O10, which form obstacles for the vehicle 1 during a parking maneuver, is relatively small.

Due to this relatively small clearance R, the vehicle 1 performs an automated parking maneuver in three maneuver moves. A target position POS1 of a first maneuver move is located on a road, wherein the vehicle 1 reverses from its starting position shown to reach this target position POS1 and steers to the left. A target position POS2 of a second maneuver move is similarly located on the road, wherein the vehicle 1 drives forwards from the starting position POS1 of the first maneuver move to reach this target position POS2 and steers to the right. A target position ZPOS of the entire parking maneuver, i.e., after completing a third maneuver move, is located on a parking space next to the object O10. The vehicle 1 reaches this target position ZPOS, starting from the target position POS2 of the second maneuver move, by reversing and steering to the left.

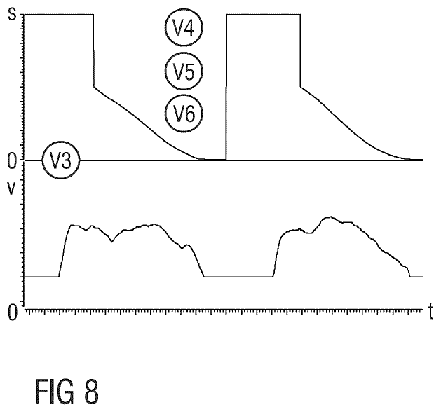

For close-range assistance systems, such as a parking assistant, targeted braking and speed control are subject to deviations during longitudinally guided maneuvering. These physically unavoidable deviations, which are dependent on a current situation in which the vehicle 1 is being operated, are taken into consideration during remaining distance control in that the remaining distance control is performed in a comfort mode or a high-precision mode depending on the situation. The core features of trajectory management performed in this way are:
different levels of control performance which perform a high-precision or comfortable longitudinal control,
taking into consideration the clearance R between the vehicle 1 and obstacles located in the surroundings of the vehicle, for example the objects O1 to O10,
taking into consideration a pitch of a surface that the vehicle 1 drives on,
taking into consideration maneuver moves of the vehicle 1, which are completed at an early stopping point, and/or
taking into consideration maneuver moves of the vehicle 1, during or after the performance of which a remaining distance s (shown in FIG. 8) falls below a specified value, i.e., which end when a remaining distance is exceeded.

In general, if the remaining distance control only has information about its own (estimated) movement and no further feedback from the vehicle environment, the remaining distance control must be supplied with information about a required guidance of the vehicle 1, which the remaining distance control must comply with for a current maneuver move.

A plurality of possible maneuvering scenarios exists, with FIGS. 1 and 2 only showing two possible examples of such maneuvering scenarios for parking the vehicle 1 in a parking space. Some further customer functions and special functions exist, such as for example a remote controlled parking function (remote parking), so-called memory parking, so-called automated valet parking, so-called piloted parking, etc., in which similarly such maneuvering scenarios are performed in the context of an automated operation of the vehicle 1. Even if a fairly similar set-up is available for a single maneuvering scenario, the sequence of the respective assistance function must be derived anew for each performance, as many different influencing factors, such as deviations in perception, dynamic objects O1 to O10, different road surface conditions, the presence of curbs and barriers, user interaction, etc. can occur.

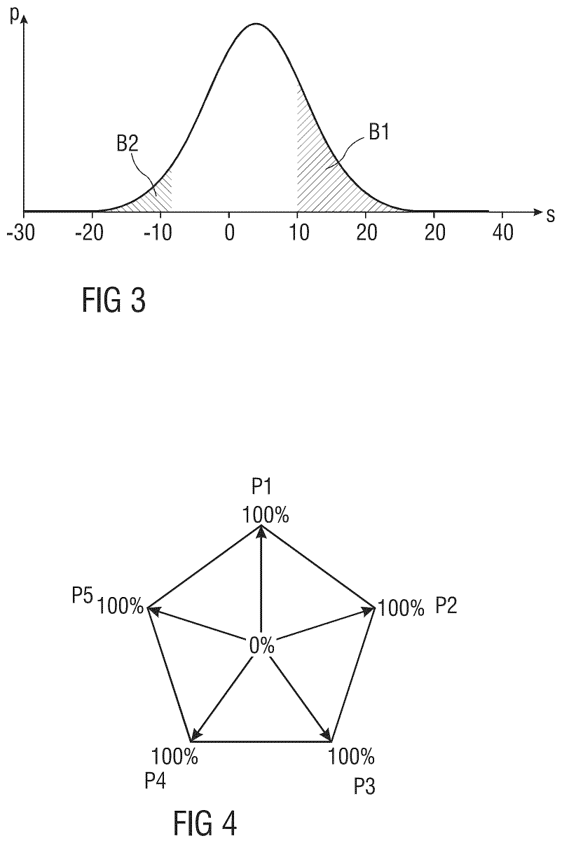

FIG. 3 shows a probability p that there will be remaining distances s after a vehicle 1 carries out targeted braking.

In most cases in which the remaining distance control stops the vehicle 1 too early, i.e., in cases in which the remaining distance s has a positive value and exceeds a specified value and thus the vehicle 1 is brought to a standstill prematurely (shown by a region B1), it is acceptable if only a small distance s remains and a destination and duration of the entire maneuver are not affected. In narrow spaces with little clearance R between the vehicle 1 and obstacles, it is however usually imperative that as much of the available clearance R as possible is used when performing the maneuver moves in order to be able to achieve a planned number of maneuver moves.

However, simultaneously, the occurrence of hard braking and exceeding the specified value of the remaining distance s (shown by a region B2) must be minimized. This can either be done by adjusting the remaining distance control in relation to the accuracy of same or by indicating that there is no need to escalate/exaggerate/increase targeted braking if the remaining distance s is exceeded. These different practices or performance capabilities are reported to the remaining distance control. A remaining distance controller, which calculates a target acceleration from a remaining distance to be driven or a target torque in a control loop, e.g., a target braking torque, should, due to the design of same, increase the braking torque requirement if the remaining distance specification is negative, since one of the following events has probably occurred in the closed-loop control, i.e., with one of more feedback variables:
errors in the disturbance variable observation (if available) such as pitch, friction coefficient, loading, etc.,
errors/scatter in the actual acceleration,
errors in the hydraulics/mechanics,
controller application.

It can be provided that in the comfort mode no such escalation should occur, since here the controller application should be designed to be more tolerant.

FIG. 4 shows a dependency diagram of various parameters P1 to P5 of a remaining distance control.

Here, a first parameter P1 relates, for example, to starting or stopping comfort, a second parameter P2 relates, for example, to a robustness against disturbances, a third parameter relates to stability and reproducibility, a fourth parameter P4 relates to a total duration of a maneuver move and a fifth parameter P5 relates to stopping accuracy.

Since these parameters P1 to P5 are at least to some extent competing, a compromise between the parameters P1 to P5 must be selected during the performance of a maneuver by the remaining distance control. The relevant regulations for setting such a compromise are already stored in the design of the remaining distance control.

To perform the remaining distance control, a remaining distance specification trajectory planner is designed to request different performance features from a higher-level and/or lower-level control system. This causes a shift in the compromises.

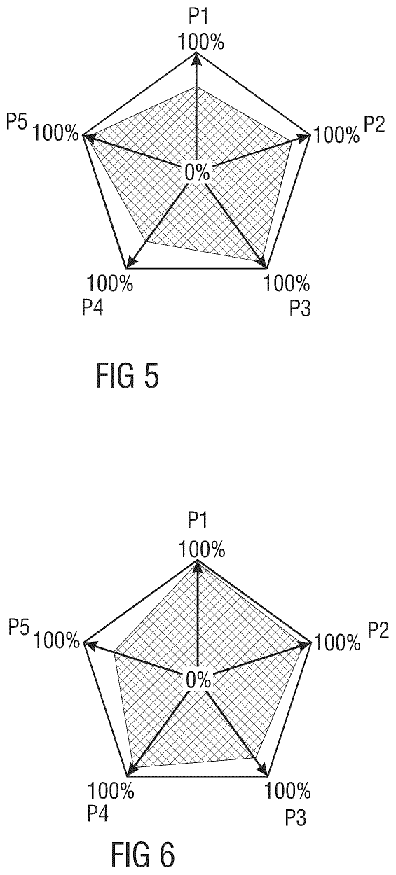

FIGS. 5 and 6 show dependency diagrams with different weightings of the parameters P1 to P5 for the high-precision mode (FIG. 5) and the comfort mode (FIG. 6) and thus examples of how a compromise between the parameters P1 to P5 can be achieved for two different features. The weighting of parameters P1 to P5 depends on what a vehicle user perceives as pleasant and is therefore at least partially subjective. There is also the possibility of configuring more than the two performance features shown (high-precision mode and comfort mode), such as an exploit stroke (maximum exploitation of the remaining distance specification). This parameter could also be assigned to the stopping accuracy, but in this case it refers to the avoidance of what the customer considers to be very unattractive overruns (starting off again in the same direction after braking too early). A remaining distance controller could also be tuned to avoid this as often as possible, which de facto results in a shift and/or compression of the standard distribution of the target braking to the left. It can be provided that the fulfilment level of this parameter for the comfort mode is the maximum or that the trajectory controller accepts the premature stopping. In high-precision mode, it can be assumed that the parameter will be complied with anyway, but a stricter controller will bring the vehicle to a stop too early more often.

In the high-precision mode, for example, the parameter P3 relating to the stability and reproducibility of the maneuver and the parameter P5 relating to the stopping accuracy are weighted higher than the other parameters P1, P2 and P4.

In comfort mode, for example, the parameter P1 relating to starting and stopping comfort, the parameter P2 relating to robustness against disturbances and the parameter P4 relating to compliance with the total duration of a maneuver move are weighted higher than the other parameters P3 and P5.

In particular, in the high-precision mode compared to the comfort mode, later points in time for starting processes for maneuver moves and a reduced target smoothness of a braking process up to a target position POS1, POS2, ZPOS are permitted as part of the setting of parameter P1, which relates to starting and stopping comfort.

In particular, the high-precision mode is also implemented in comparison to the comfort mode in the context of the setting of parameter P2, which relates to the robustness against disturbances, in such a way that surface properties of a surface that the vehicle 1 drives on have a minimal influence on the degree of precision, and rolling back of the vehicle 1 when starting off on an incline and/or driving over a curb is not permitted. In particular, a release for rolling the vehicle 1 towards the engaged driving position is selected depending on the clearance R and if the remaining distance s is exceeded in the last maneuver move, for example during hard braking.

In particular, in the high-precision mode, compared to the comfort mode, it is still assumed in the context of the setting of parameter P3, which relates to the stability and reproducibility of the maneuver, that the stability and reproducibility are mandatory prerequisites for a high degree of precision and that a permissible tolerance with respect to exceeding a maximum speed of the vehicle 1 is minimal.

In particular, the high-precision mode continues to be implemented in comparison to the comfort mode in the context of the setting of parameter P4, which relates to the total duration of a maneuver move, in such a way that compliance with the total duration of a maneuver move is prioritized less.

In particular, in the high-precision mode, compared to the comfort mode, a lower possible number of permitted vehicle maneuver moves are permitted within the context of the setting of parameter P5, which relates to the stopping accuracy, during or after the performance of which a remaining distance s falls below a predefined value, a lower standard deviation is permitted and maneuver moves of the vehicle 1 which are completed at an early stopping point are avoided and, if necessary, continued.

The high-precision mode is activated, for example, when there is little clearance R in the direction of travel to the respective target position POS1, POS2, ZPOS. The number of maneuver moves can also be minimized by avoiding the non-utilization of a specified remaining distance s and thus avoiding additional maneuver moves. It is also permitted to continue a maneuver move after the vehicle 1 has come to a standstill if premature target braking occurs. Furthermore, the high-precision mode will also be performed particularly in narrow situations, for example when an entire maneuver takes place in a constricted environment, such as a one-way street, and all maneuver moves must be performed with a high degree of precision, even though a current target position POS1, POS2, ZPOS offers sufficient clearance R. Furthermore, the high-precision mode is also performed, in particular, in the case of nearby obstacles in order to avoid travelling over a target position POS1, POS2, ZPOS when travelling in the direction of an obstacle. Furthermore, the high-precision mode is also performed in the case of close dynamic obstacles, wherein collision avoidance algorithms can request a strict restriction to a maximum speed of the vehicle 1, in order to ensure that a collision is avoided in a current situation.

By contrast, in the comfort mode compared to the high-precision mode, in particular earlier points in time for starting processes for maneuver moves and a higher target smoothness of a braking process up to a target position POS1, POS2, ZPOS are permitted as part of the setting of parameter P1, which relates to starting and stopping comfort.

In particular, the comfort mode is also implemented in comparison to the high-precision mode in the context of the setting of parameter P2, which relates to the robustness against disturbances, in such a way that rolling back of the vehicle 1 when starting off on an incline and/or driving over a curb is permitted. In particular, a release for rolling the vehicle 1 towards the engaged driving position is selected depending on the clearance R and if the remaining distance s is exceeded in the last maneuver move, for example during hard braking.

In particular, the comfort mode is also implemented in comparison to the high-precision mode in the context of the setting of parameter P3, which relates to the stability and reproducibility of the maneuver, in such a way that a greater tolerance is permitted with respect to exceeding a maximum speed of the vehicle 1 and/or a reduced reproducibility of a maneuver move is permitted.

In particular, the comfort mode is also implemented in comparison to the high-precision mode in the context of the setting of parameter P4, which relates to the total duration of a maneuver move, in such a way that, while adhering the total duration of the maneuver move, an acceleration of the starting process is permitted, an acceleration for reaching a maximum speed of the vehicle 1 is permitted and a greater smoothness of the braking process at a target position POS1, POS2, ZPOS is specified.

In particular, in the comfort mode, compared to the high-precision mode, a greater possible number of allowed vehicle maneuver moves are permitted within the context of the setting of parameter P5, which relates to the stopping accuracy, during or after the performance of which a remaining distance s falls below a specified value, a greater possible number of allowed maneuver moves of the vehicle which are completed at an early stopping point are permitted, and a greater standard deviation is permitted. Maneuver moves can also be aborted and planned again. Maneuver moves with early stopping points are permitted, for example, when the high-precision mode is switched to the comfort mode because there is more clearance R available

The comfort mode is activated, for example, when there is a large clearance R in the direction of travel towards the respective target position POS1, POS2, ZPOS.

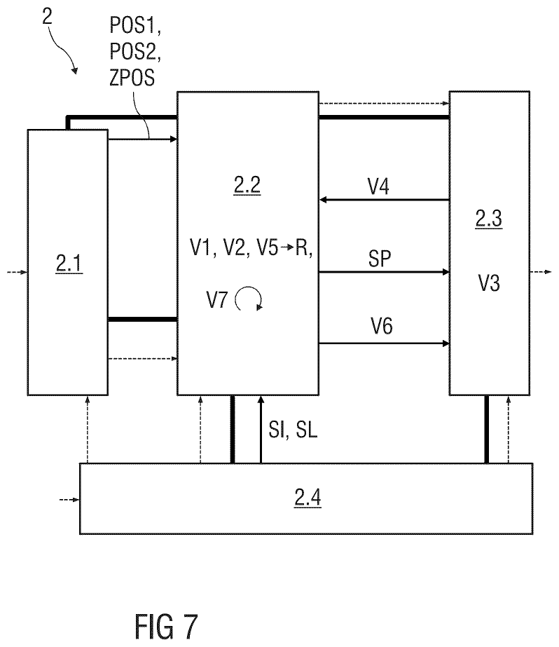

FIG. 7 shows a block diagram of a possible exemplary embodiment of a system 2 for a remaining distance control for a vehicle 1.

The system 2 comprises a model 2.1 of the real world, a trajectory management module 2.2, a remaining distance control module 2.3, and an ego motion module 2.4.

The trajectory management module 2.2, which is formed on-board in the vehicle 1 or in an infrastructure external to the vehicle, receives the respective target position POS1, POS2, ZPOS of a maneuver move from the model 2.1 of the real world and from the ego motion module 2.4, which determines ego motion data of the vehicle 1, for example from an inertial measurement sensor system, a radar-based sensor system, and/or a proximity speed detection system, in particular standstill information SI and information SL about a pitch of a surface that the vehicle 1 drives on.

Depending on the respective target position POS1, POS2, ZPOS of a maneuver move and on other environmental and vehicle parameters, the trajectory management module 2.2 determines, in a process step V2, a current situation and corresponding control parameters SP, for example a remaining distance of the vehicle 1 to an obstacle and a maximum speed of the vehicle 1 in a maneuver move and transmits these to the remaining distance control module 2.3.

The remaining distance control module 2.3 starts in a process step V3 with the remaining distance control including a performance request for a current situation or scene and a respective maneuver move. The performance request includes which mode, i.e., the comfort mode or high-precision mode, the remaining distance control is to be performed in.

Furthermore, the remaining distance control module 2.3 determines, in particular continually, in a process step V4, an estimated stopping distance and transmits this to the trajectory management module 2.2.

Depending on this estimated stopping distance, in a process step V5, the trajectory management module 2.2 determines a clearance R of the vehicle 1 to an obstacle at the respective target position POS1, POS2, ZPOS of a maneuver move.

If necessary, the trajectory management module 2.2 makes a request in a further process step V6 to change the performance request, i.e. to change from comfort mode to high-precision mode or from high-precision mode to comfort mode.

After performing a target braking maneuver, the trajectory management module 2.2 receives a result of the target braking in a further process step V7 and decides whether the result is acceptable. After each target braking maneuver, the trajectory management module 2.2 stores a remaining distance s and decides based on this remaining distance, the stopping distance estimated in process step V4 and the result of the target braking maneuver whether the trajectory needs to be replanned.

The respective next maneuver move then proceeds in the high-precision mode in order to reach the corresponding target position POS1, POS2, ZPOS, taking into consideration the last value of the remaining distance s when the comfort mode is selected, until the target position ZPOS of the entire maneuver is reached.

FIG. 8 shows the course of a remaining distance s and a vehicle speed v as a function of the time t during a maneuver with two maneuver moves, for example a parking maneuver as shown in FIG. 1.

In addition to decelerating the vehicle 1, the remaining distance control also accelerates the vehicle 1 in order to carry out a complete maneuver move from moving off to coming to a standstill again.

The temporal positions of process steps V3 to V6 are shown.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for closed-loop remaining distance control of a remaining distance for a vehicle in order to stop the vehicle at a specified stopping position, wherein the control of the remaining distance control is performed in one of either of two modes, wherein a first of the two modes is a comfort mode and a second of the two modes is a high-precision mode, the method comprising:
guiding the vehicle to the specified stopping position in several specified maneuver moves, wherein individual maneuver moves of the several specified maneuver moves each end in a target position where the vehicle is to be stopped;
determining, taking into consideration at least one already performed maneuver move, a current situation; and
selecting, depending on the determined current situation and from the two modes, which of the two modes is used to perform the remaining distance control, wherein the selection is based on a comparison of the determined current situation with a list of specified situations, wherein which of the two modes in which the remaining distance control is to be carried out is predetermined in the list for each of the specified situations.

12. The method of claim 11, wherein the determined current situation is compared to the list with the specified situations by identifying a specified situation corresponding to the determined current situation in the list with the specified situations as a function of the determined current situation and selecting from the two modes mode predetermined for the specified situation perform the remaining distance control.

13. The method of claim 11, wherein the determination of the current situation considers a maneuver performance accuracy of the at least one already performed maneuver move.

14. The method of claim 11, wherein the determination of the current situation accounts for a stopping accuracy with which the vehicle has reached a respective target position in at least one performed maneuver move.

15. The method of claim 11, wherein the determination of the current situation accounts for at least one performed maneuver move that is completed at an early stopping point before reaching a respective target position.

16. The method of claim 11, wherein the determination of the current situation accounts for at least one maneuver move, during or after the performance of which a remaining residual travel to a respective target position falls below a specified value.

17. The method of claim 11, wherein scatter in stopping accuracies of all of performed maneuver moves is identified, stored, and considered when determining the current situation.

18. The method of claim 11, wherein the determination of the current situation considers:
a pitch of a surface that the vehicle drives on; or
a clearance between the vehicle and at least one obstacle.

19. The method of claim 11, wherein, compared to the high-precision mode, in the comfort mode:
a greater possible number of allowed maneuver moves of the vehicle is specified, during or after the performance of which a remaining distance falls below a specified value;
a greater possible number of allowed maneuver moves of the vehicle that are completed at an early stopping point is specified;
an earlier possible point in time for a starting process in a maneuver move is permitted;
a greater target smoothness of a braking process up to a target position is specified;
the vehicle is permitted to roll back when starting on an incline or driving over a curb;
a greater tolerance is permitted with respect to exceeding a maximum speed of the vehicle;
a reduced reproducibility of a maneuver move is permitted; or
an acceleration of the starting process is permitted while adhering to a total duration of a maneuver move, an acceleration for reaching the maximum speed is permitted, and a greater smoothness of a braking process at a target position is specified.

20. The method of claim 11, wherein, compared to the comfort mode, in the high-precision mode:
a smaller possible number of allowed maneuver moves of the vehicle is specified, during or after the performance of which a remaining distance falls below a specified value;
a continuation of maneuver moves of the vehicle, which are completed at an early stopping point, is permitted;
later points in time for starting processes in maneuver moves are permitted;
a reduced target smoothness of a braking process up to a target position is permitted;
the vehicle is not permitted to roll back when starting on an incline or driving over a curb;
a smaller tolerance is permitted with respect to exceeding a maximum speed of the vehicle;
an increased reproducibility of a maneuver move is specified; or
a low prioritization of adhering to a total duration of a maneuver move is permitted.
